(19) United States
(12) Patent Application Publication
(10) Pub. No.: US 2003/0208718 A1
(43) Pub. Date: Nov. 6, 2003

(54) Method and system for designing and ordering custom printed promotional items using the internet

(76) Inventors: Patricia M. Mulvey, Neenah, WI (US); Michael A. Goudreau, Omro, WI (US); Gina L. Piarulli, Menasha, WI (US)

Correspondence Address: QUARLES & BRADY LLP, 411 E. WISCONSIN AVENUE, SUITE 2040, MILWAUKEE, WI, 53202-4497, US

(21) Appl. No.: 10/137,882

(22) Filed: May 1, 2002

(51) Int. Cl. G06F 17/00

(52) U.S. Cl. 715/502

(57) ABSTRACT

A method and system for designing printed promotional items are disclosed. The method includes providing onto a computer network first information concerning a plurality of possible characteristics of a printed promotional item. The method further includes receiving from the computer network second information submitted by a user customer and concerning a desired characteristic of the printed promotional item. The method additionally includes providing onto the computer network third information concerning a proposed design for the printed promotional item for review by the user customer.

### FIELD OF THE INVENTION

The present invention relates to a method and system for designing and ordering printed promotional items such as labels and coupons. In particular, the present invention relates to a method and system for designing and ordering such promotional items by way of the Internet.

### BACKGROUND OF THE INVENTION

Printed promotional items such as labels and coupons are an important mechanism by which manufacturers, retailers and other promoters are able to promote their products. In addition to the common cut-out coupons that are provided in, for example, newspapers, a variety of more specialized types of printed promotional items are now made available in numerous promotional settings. Such printed promotional items need not be strictly limited to promotional items having only one sheet; that is, printed promotional items can be understood to include two or more sheets that are attached to one another, multi-fold promotional items or promotional items with multiple pages.

Two specialized types of printed promotional items that are commonly utilized today are the “On-Pack” promotional item and the “Off The Shelf” promotional item, both of which have become ubiquitous within retail establishments. The On-Pack promotional item is a two-layer or “two-ply” adhesive label that is affixed to the packaging of a product or a product container. Typically, a top sheet of the On-Pack promotional item has promotional information such as a coupon printed on it, while a bottom or base sheet of the promotional item may be made from a clear or transparent material such as plastic. A dry residue adhesive is employed to attach the top layer to the bottom layer, while the bottom layer is attached directly to the product packaging or container by way of a more permanent adhesive. Through the use of the dry residue adhesive between the top and bottom layers, the top layer can be removed from the bottom layer by a customer without leaving any sticky residue behind on the exposed surface of the bottom layer. Such a coupon is described more fully in U.S. Pat. No. 4,479,838 to Dunsirn et al., which is hereby incorporated by reference herein. In alternate embodiments, On-Pack promotional items can include more than two sheets that are attached together.

The Off The Shelf promotional item is a it dispenser of sheet items that is made available on a shelf within a store so that the customer can take the sheet items (e.g., coupons) “off the shelf”. Typically, numerous copies of the Off The Shelf promotional item are provided at a particular location in a dispenser or coupon holder. The dispenser of Off The Shelf promotional items is located on or near the particular shelf or shelves at which the products that are the subject of the Off The Shelf promotional items are located. Depending upon the circumstance, Off The Shelf promotional items need not be limited to single-sheet promotional items, and instead can be multi-fold promotional items or multiple-page promotional items.

Of course, these are just two different types of printed promotional items. There are many others to which the present invention could be applied.

Promoters wishing to use printed promotional items typically order the promotional items from companies or other parties that print or otherwise manufacture or provide the promotional items (who can generally be referred to as “providers”). Despite the great popularity of printed promotional items such as the On-Pack and Off The Shelf promotional items, certain inefficiencies exist in the process by which new promotional items are designed and then ordered. In order for a provider to produce a promotional item that sufficiently meets the expectations of a promoter, often the provider and promoter must repeatedly communicate with one another and revise the tentative design of the promotional item. There are many variables in the design of printed promotional items, among them, color, font style and size, background design, size, logos, trademarks, layouts, promotion terms, discounts, etc. all of the decisions that must be made to create the artwork, terms, and size of the item. This is particularly the case where the preferences of a given promoter differ from what the promoter has done in the past. Further, the design and ordering process requires a significant amount of bureaucratic work, such as the taking and processing of orders by the provider. It is often difficult to streamline this bureaucratic work, even where a promoter and provider have an ongoing relationship concerning numerous promotional items. Oftentimes many iterations and exchanges of samples are necessary for the promoter to proof and ultimately approve the finished design of the item.

These inefficiencies in the process of designing and ordering promotional items are significant, particularly since the useful lifetime of any given promotional item is usually short, and since new promotional items can become necessary for any of a number of reasons. For example, new or modified promotional items typically must be generated each time a new product is being offered, or each time the promoter of a product desires to offer new terms of sale, discount or promotion. Consequently, this process of designing and ordering printed promotional items must necessarily be repeated over and over again at a frequent pace.

Because of the inefficiencies that currently exist in the process of designing and ordering printed promotional items, and because this process must frequently be repeated each time a new promotional item is desired, it would be advantageous if a new, simpler method and system were developed to allow promoters to work with providers in designing, and then ordering, printed promotional items. It would further be advantageous if the method and system provided standardization of the design process, and yet at the same time offered sufficient design flexibility to account for most design preferences of promoters ordering the promotional items. It would additionally be advantageous if the method and system eliminated or streamlined bureaucratic work that currently exists in the process for designing and ordering promotional items. It would further be advantageous if the method and system accounted for ongoing relationships between certain promoters and providers, and thereby further streamlined the process of designing and ordering promotional items with respect to these parties, thereby speeding time to market.

### SUMMARY OF THE INVENTION

The present inventors have discovered a new method and system by which promoters are able to work with providers to design custom printed promotional items by way of the Internet, proof them on their computer terminal screen and place an order. The method and system in particular allows a promoter to establish an account with the provider of the promotional items and, upon establishment of the account, allows the promoter to log in to the account. Once logged in, the promoter is able to interact with web pages in order to design a desired customized promotional item. During this interaction, the promoter is presented with a number of options concerning the type of printed promotional item that is desired and, once a particular type of promotional item is selected, options concerning various features of the promotional item that can be selected by the promoter.

Additionally, the promoter is required, or presented with an option, to enter specific information where appropriate to complete certain fields or other features within the promotional item. The nature and scope of specialized information that is provided by the promoter will vary depending upon the embodiment or circumstance. For example, in certain embodiments, the information supplied by the promoter will concern only limited, substantive information necessary for setting forth or identifying a promotion, e.g., the expiration date of a coupon. In alternate embodiments, the information supplied by the promoter can more generally concern the form or appearance of the promotional item, e.g., graphic images to appear within a coupon. Once the design and proofing of the promotional item is completed, the promoter is further provided with an order form by which the promoter can order a desired quantity of the promotional items from the provider. Another benefit of the invention is that a method of the invention consolidates all of the promotional item design elements and allows them to be used by geographically disparate users to promote promotion consistency and ease of use.

In particular, the present invention relates to a method of designing printed promotional items. The method includes providing onto a computer network first information concerning a plurality of possible characteristics of a printed promotional item. The method further includes receiving from the computer network second information submitted by a user customer and concerning a desired characteristic of the printed promotional item. The method additionally includes providing onto the computer network third information concerning a proposed design for the printed promotional item for review by the user customer.

The present invention further relates to a method of designing and ordering a printed promotional item. The method includes providing a first web page onto the Internet, where the first web page includes at least a first field within which a user customer identity can be specified, and receiving first information including an identifier indicative of a particular user customer identity. The method additionally includes providing a second web page onto the Internet, where the second web page includes a list of different printed promotional items, and receiving second information indicative of a particular printed promotional item selected from the list of different printed promotional items. The method further includes providing a third web page onto the Internet, where the third web page includes at least one of a second field and a list of selectable characteristics, and receiving third information indicative of a specified characteristic for the particular printed promotional item. The third information is one of specified information that was entered by the user customer into the second field and selected information that was selected by the user customer from the list of selectable characteristics.

The present invention additionally relates to a system for designing and ordering printed promotional items. The system includes processing means for executing a web server application program, storing a set of web pages, and communicating with user customer computers via the Internet. The processing means is capable of sending web page information onto the Internet and is capable of receiving user customer-provided information off of the Internet. The set of web pages includes a web page having information concerning a plurality of possible characteristics of at least one printed promotional item, and another web page including an order form.

In the description, reference is made to the accompanying drawings, which form a part hereof, and which illustrate examples of the invention. Such examples, however, are not exhaustive of the various embodiments of the invention, and therefore, reference is made to the claims, which follow the description, for determining the scope of the invention.

### BRIEF DESCRIPTION OF THE DRAWINGS

FIG. 1 is a schematic diagram of a computer network organization, and in particular shows a server providing a site on the World Wide Web (Internet) according to one embodiment of the present invention;

FIGS. 2-8 are exemplary screen displays seen on a user customer's computer in FIG. 1.

### DETAILED DESCRIPTION OF THE PREFERRED EMBODIMENT

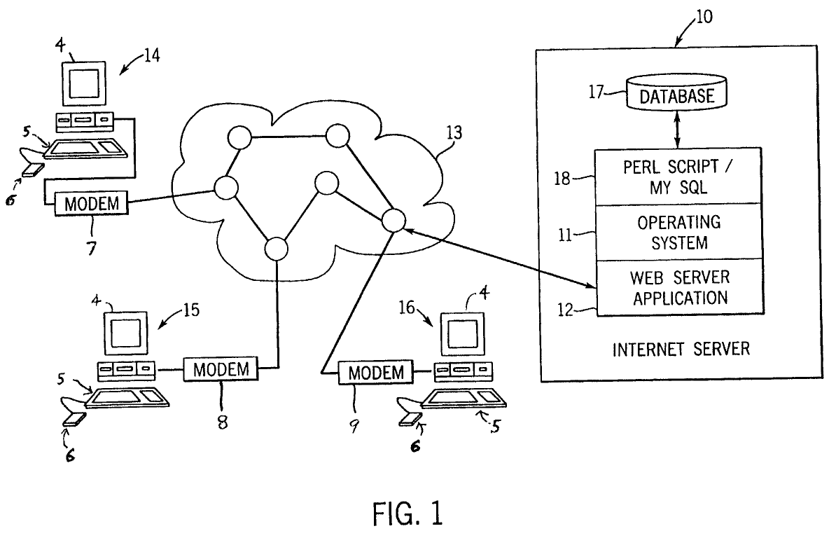

Referring to FIG. 1, the system of the present invention includes a server computer 10 which is capable of hosting a web site on the World Wide Web of networks (also known as the Internet) and running Sun Solaris, Windows NT, Linux or another compatible operating system 11. The server computer 10 is owned and operated by, or otherwise hosts the web site on behalf of, a provider (e.g., printer or manufacturer) of printed promotional items. In addition to a stand-alone web site, the invention can be hosted in a larger operation with other web sites, as is well known in the art. Firewalls and other security measures of a type known in the art can be incorporated in the web site, but are not shown.

Also shown in FIG. 1 are three user customer computers 14, 15 and 16, which connect to the server computer 10 through the Internet 13 represented as a group of connected nodes. The user customer computers 14-16 are operated by user customers, who are employees of or otherwise represent promoters that wish to work with the provider to design and order printed promotional items. Each of the user customer computers 14-16 includes at least one user customer interface such as a keyboard 5 or a mouse 6, and also includes a display or other output device. The user customer computers 14-16 connect to the Internet 13 through modems 7-9, respectively, or other suitable Internet connections of a type known in the art. The user customer computers 14-16 use well known browser software such as Microsoft Explorer or Netscape Navigator.

The server computer 10 runs a web server application program 12 for communicating with the user customer computers 14-16. The web server application program 12 manages application requests, and transmits requested information to the user customer computers 14-16. The web server application program 12 enables the server computer 10 to keep track of which of the user customer computers 14-16 is associated with each specific information request, and ensures that the information is properly transmitted.

The server computer 10 also manages a database 17, stored in a memory storage device of suitable capacity. The database is managed by a database management program 18, such as MY SQL or Oracle. In a MY SQL application, the application is configured and characterized by scripts written in PERL to define the database organization and execute database management functions. The MY SQL application also includes certain utility routines. The basic architecture provides a collection of web pages, which are called up and transmitted to the user customer computers 14-16 as the computers access the web site. Although a computer network employing a server computer, user customer computers and the Internet is described above, the present invention is also applicable to other types of computer networks, including networks employing wireless communications. It should also be noted that as used herein, a local computer network could be a single computer, or multiple computers.

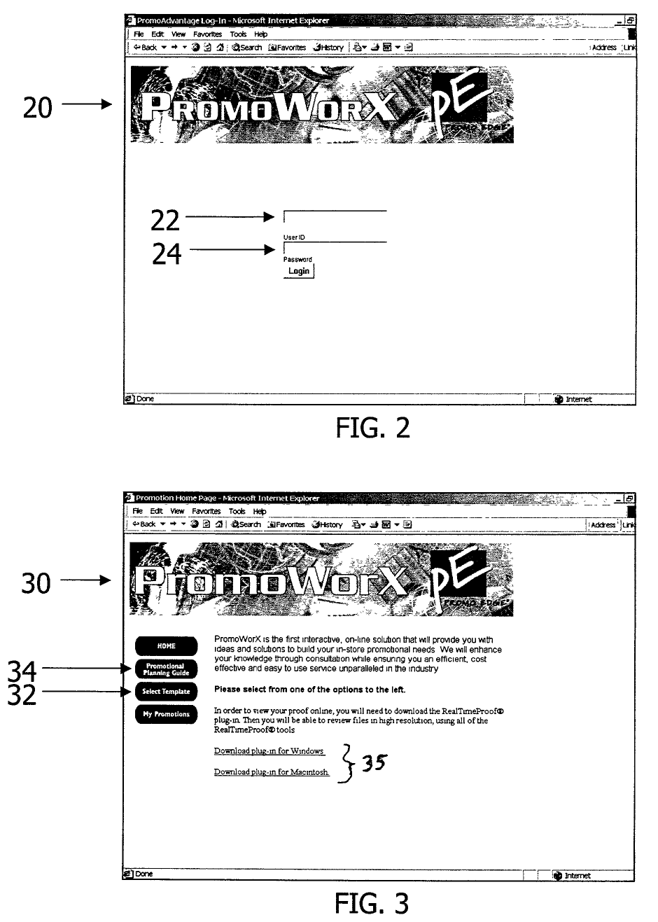

Turning to FIGS. 2-8, exemplary web pages or screens 20, 30, 40, 50, 60, 70 and 80 are respectively shown, which are downloadable from the server computer 10 at the user customer computers 14-16 via the Internet 13. The web pages 20-80 allow user customers representing promoters to design and order printed promotional items from the provider. More specifically, the web pages 20-80 provide an interface by which the user customers are able to provide information to the provider concerning the desired features for their printed promotional items, and to submit orders to the provider. The downloading of the web pages 20-80, submission of information to the server computer 10 by user customers interacting with the web pages and other interaction of the user customer computers 14-16 with respect to the server computer and the web pages 20-80 form steps of a process for designing and ordering the printed promotional items.

Referring to FIG. 2, one of the user customer computers 14, 16 is directed by a user customer to download a first web page 20 of the provider's website. The web page 20 provides two fields 22, 24 into which the user customer can input a user customer name and a password, respectively, in order to log in to the web site operated by the server computer 10. In an alternate embodiment, another added box is provided that can be checked by new user customers to indicate that they have not previously logged in. Depending upon the embodiment, the web page 20 can also provide various information concerning the provider, other information of interest to promoters, as well as advertisements such as banner ads.

Upon logging in, a home web page 30 appears, in which the user customer can begin creating a promotion. The home web page 30, as well as subsequent web pages discussed below, can be tailored in terms of their organization and design to a particular customer as identified by the particular user customer's login and password. Indeed, the available categories, types and formats for promotional items can vary depending upon the customer's needs; that is, a user customer from company A would have a certain set of templates, colors, logos, trademarks, layouts, promotion terms, discounts, type styles and other design elements, which would be different from the set provided to a user customer from company B.

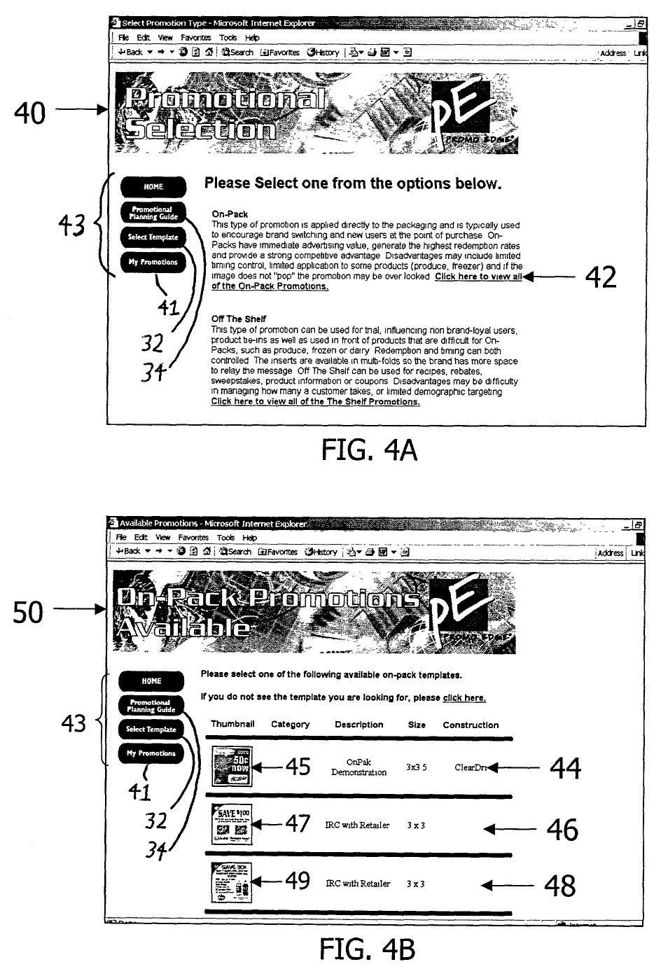

As shown, the home web page 30 includes a button 32. Selection of the button 32 by a user customer causes an additional web page 40 (see FIG. 4A) to appear, on which are displayed different possible categories of promotional items that the user customer can design. Also, the home web page 30 includes other buttons such as a Promotional Planning Guide button 34. The button 34 allows user customers who are not familiar with the system, or who are not familiar with the offerings of the provider that is operating the system, to learn about the various categories of promotional items that are available from the provider. A further set of buttons/links 35 on the web page 30 allows for a user customer to obtain software plug-ins that are useful in interacting with the system. The desired promotional item can be selected by the user customer using the user customer interface devices 5, 6.

Referring to FIG. 4A, upon selection of button 32, different possible categories of promotional items are listed in a further web page 40. As noted, the categories of promotional items can be tailored to different customers. In the embodiment shown in FIG. 4A, two available categories of promotional items are available, namely On-Pack promotional items (which are labels) and Off the Shelf promotional items (which are loose sheet items). Typically, these items are used as coupons. Additionally, the web page 40 also provides additional information concerning why a promoter would wish to select a particular type of coupon, as well as some of the common applications for that type of coupon and the common competitive advantages and disadvantages of using that type of coupon.

In alternate embodiments, other or different categories of promotional items can be available than those shown in FIG. 4A. Such items can include other types of labels or sheet items, game pieces, pop materials (“pop” stands for “point of purchase”), coupons, packaging and regional promotions, recipes, rebates, sweepstakes, or specialized product information. Depending upon the embodiment, the different categories of promotional items can be listed based upon their structural characteristics, the intended purposes of the promotional items, or along other lines. Regardless of the particular manner in which different categories of promotional items are listed, all possible printed promotional items that may be of interest to a given promoter and that are available from the provider should be available upon selecting button 32.

Clicking on a button 42 in the web page 40 or on the hyperlinked phrase “Click here to view all of the On-Pack Promotions” causes a subsequent web page 50 to appear, as shown in FIG. 4B. The web page 50 shows specific information concerning the types of On-Pack coupons available to (tailored for) the specific user customer, or such information in a more generic format for all user customers. At least some of these templates preferably include colors, backgrounds, designs, graphics, trademarks, logos, terms and conditions, discounts, typefaces, logos and other design elements which are tailored for the specific user customer, and perhaps provided by the user customer and not accessible by other user customers or user customers of other companies. As shown in FIG. 4B, the On-Pack promotional items category includes, but is not limited to, three different coupon types 44, 46, and 48.

The web page 50 also provides thumbnail images 45, 47 and 49 of the different coupon types, as well as information concerning each coupon type's category, description, size, and construction methods (in an alternate embodiment, pricing information is also listed). Further, the web pages 40 and 50 of FIGS. 4A and 4B. respectively, continue to include selectable options 43 (also provided on the home web page 30). These include buttons to return to the home web page 30, the Promotional Planning Guide button 34, the button 32 (to return to the web page 40), and a My Promotions button 41. The My Promotions button 41 in particular can be selected by a user customer to provide the customer with historical information regarding previous promotional items created by the user customer. In alternate embodiments, additional or different information can be provided on the web pages 40 and 50 other than that shown.

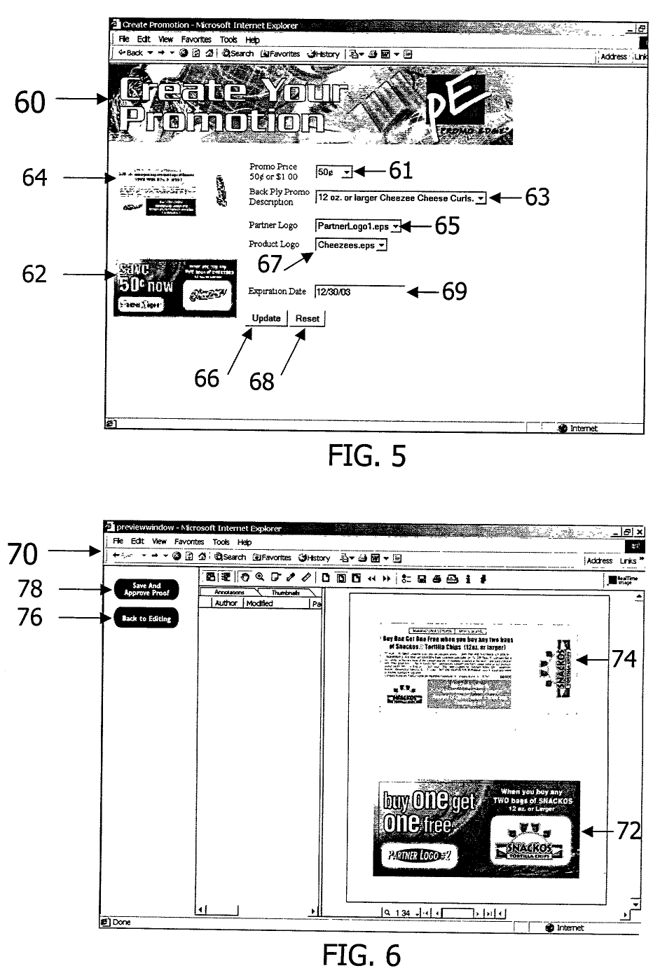

A user customer chooses to design a particular coupon having one of the available types 44, 46 or 48 by selecting that coupon type, e.g., by clicking on one of the thumbnail images 45, 47, or 49. Turning to FIG. 5, now that the user customer has selected a particular category and type of promotional item that it wishes to design and presumably order, the web page 60 appears allowing for the input of various specific design features/formats which may be keyed to the specific user. In the embodiment of FIG. 5, the user customer can input information concerning five specific attributes of the particular coupon. In particular, the user customer can input the promotional price or coupon offer in a first field 61 and pre-approved verbiage for the back copy of the coupon in a second field 63.

In addition, a company name or a particular design of that name indicative of the promoter or a corporate sponsor of the coupon can be entered in a third field 65. In addition, for any of these design elements, the user customer may be permitted an option whereby the user customer can import from his local computer network new design features which previously were not stored on the provider's network. More or fewer attributes may be selectable by the user in practicing the invention. These attributes are preferably keyed to the user, or at least some of them are, such as the corporate name, logos, type style, colors, promotion terms and other variables in the design of the promotional items.

Also, the user customer can specify a desired product image by selecting one of the images provided in a list 67. The product images that can be selected by the user customer can be any of a number of standardized and pre-defined images showing boxes, bottles, cans, or other common products. In alternate embodiments, the product images in the list 67 are a standard set of graphic images that have been provided by the user customer (or another representative of the promoter) at an earlier time and may be keyed to the user customers, so that other unauthorized users do not have access to them. Tn such embodiments, it is envisioned that some promoters will have an ongoing relationship with the provider and will frequently return to the presently-described website to design and order new or updated coupons. Such promoters would be highly likely to have particular preferences for their coupons that would be repeatedly applicable to successive coupon designs. Providing special lists for these promoters, accessible by them and not by other users, would enable the provider to better satisfy these particular preferences of such promoters.

Referring still to FIG. 5, a fifth field 69 is provided into which the user customer can input an expiration date of the coupon. Additionally, in an alternate embodiment, it is envisioned that another field is provided into which the user customer can input specific bar code information. Further as shown in FIG. 5, exemplary front and back side views 62 and 64, respectively, of the coupon are also provided on the web page 60 to show where the information specified by way of the fields 61, 63, 65, 67 and 69 will be positioned on the coupons. Once all of the necessary information has been provided by the user customer, the user customer can submit the information to the server computer 10 by clicking on an Update button 66. Also, a reset button 68 is provided in case the user customer wishes to delete previous entries in the fields 61, 63, 65, 67 and 69 and begin again. Depending upon the embodiment as well as the category/type/format of promotional item that is being designed, the exact types of information that can be specified by a user customer by way of the fields and list 61-69 (or other similar elements For entering information) will differ from that shown in FIG. 5. Also, depending upon the embodiment, as well as upon the category/type/format of the promotional item being designed, certain information can be required, while other information can be optional.

Referring to FIG. 6, after submission of the information concerning the design of the coupon, the web screen 70 is displayed. The web screen 70 provides a view of how the coupon will appear when printed. Both a front side 72 and a back side 74 of the coupon are provided for proofing by the user customer. If the user customer does not approve of the design of the coupon as shown in the web page 70, the user customer can return to the web screen 60 to modify the information that was previously input, either by pressing a back button on the Internet browser program or an edit button 76. Assuming that the user customer approves of the current design of the coupon, the user customer can indicate approval by pressing an accept button 78 in FIG. 6.

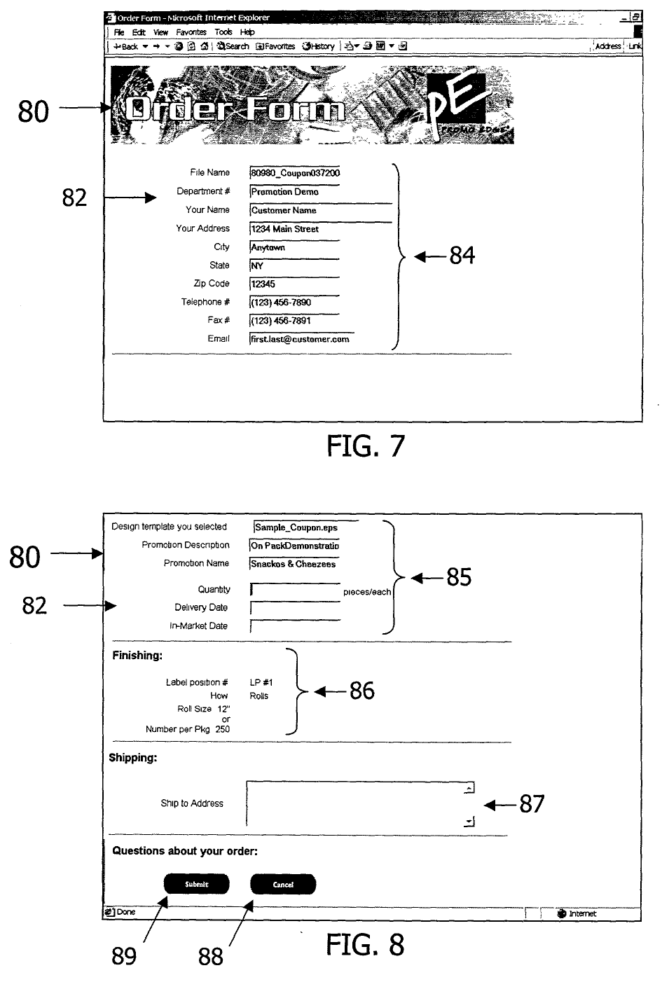

Once the design of the coupon is approved, the web page 80 of FIG. 7 appears, in which the user customer is presented with an order form 82 by which the user customer can order copies of the coupon to be made by the provider. In the embodiment shown, the order form 82 includes a group of ten fields, 84, for entering information that is necessary for processing the order. Much of this data is pre-populated based on the user customer's data that is captured at the time of login. Specifically, the user customer is requested to make any necessary changes to contact information fields such as the user customer's personal name, the promoter's corporate street address, city, state, zip code, telephone number, fax number, and email address. In addition, file name and department number information is obtained, for identification purposes.

FIG. 8 continues web page 80 with specific groups of fields necessary for processing the order. In FIG. 8, fields pertaining to order information 85, finishing information 86, and shipping information 87, are necessary for the production process to begin. Once the information is properly entered, the user customer can submit the order by way of a submit button 89. If various information must be changed, the user customer can instead select a cancel button 88. In alternate embodiments, less than all of the information shown in the exemplary order form 82 is required for processing orders and so the order forms in those embodiments do not require as much information as is required by the order form that is shown. Also, in alternate embodiments, additional or different information is required in addition to that shown in FIGS. 7 and 8, such as date needed, and fields for submitting required authorizations, such as for indicating a purchase order number from the customer. In addition, a screen showing terms and conditions of the sale of the promotional items to the user customer may be shown at this time, to which the user customer must agree, by clicking through, before the order is acknowledged. After submitting screen 80 or any required subsequent screens, a screen may be provided by the system which tells the user customer that her/his order has been accepted, or that he/she will be contacted regarding the order.

The present embodiment of the invention shown in FIGS. 1-8 is an exemplary embodiment of the invention as it pertains to certain printed promotional items. The exact number, structure, and relative ordering of the different web pages will vary depending upon the embodiment, and also will vary depending upon the categories, types, and formats of printed promotional items that are available for design and ordering. For example, the information provided on some of the web pages 30, 40, 50, 60, 70, or 80 could potentially appear in one or more web pages that appeared prior to the logging in of a customer via the web page 20, so that prospective customers could get a better sense of how the present system operated. Also, for example, the web pages used in the present system will vary from the web pages 20-80 in the case where the printed promotional items being designed or ordered are bumper stickers or hang tags as opposed to On-Pack promotional items.

Also, depending upon the embodiment, the web pages will allow additional or different functionality than that discussed with respect to FIGS. 2-8. For example, in embodiments where it is not required that user customers log in in order to design and order promotional items, the order form provided in the web page 80 could include an additional field for a credit card number, as well as fields for the name on the credit card and the expiration date of the credit card. Additionally, designs that have been developed by user customers can be saved to disk or other storage devices for later retrieval by the user customers, in addition to being stored by the server computer 10. In certain embodiments, promoters themselves can have printing devices by which the promoters are able to print promotional items that have been designed using the system. Not all of the steps listed above need to be performed in every case; for example, in a case where a particular promoter has a long-term course of dealings with the provider, it may not be necessary for the promoter to complete an order form.

Additionally, the information that can be provided in the fields such as those shown in FIG. 5 will vary depending upon the type of promotional item, and can include different or additional information from that shown. For example, the information that can be provided by a user customer can include structural information concerning the number or types of layers of the promotional item, the surface area of the item, and whether the item has a particular scent (e.g., in the case of coupons for fragrances). Also, the information provided by a user customer can include additional substantive information, such as disclaimer information. In most embodiments, templates for standard types of printed promotional items will be available for selection by the user customer, and the user customer will in turn be allowed to specify certain standard design characteristics. These templates and design elements or characteristics can be keyed (i.e., “keyed” meaning that they have access to certain templates, design elements or characteristics which are germain to their product and not ones of other users) into the specific user or a particular group of users, e.g., all of the promotional marketing employees of a particular company who is sponsoring the promotion, who will then be able to design, proof and order printed promotional items for the company's products.

This has been a description of the preferred embodiments of the method and apparatus of the present invention. Those of ordinary skill in this art will recognize that modifications might be made while still coming within the spirit and scope of the invention and, therefore, to define the scope of the various embodiments of the invention, the following claims are made:

We claim:

1. A method of designing printed promotional items comprising:
providing onto a first local computer network first information concerning a plurality of possible characteristics of a printed promotional item;
providing communication between the first local computer network and a second local computer network;
receiving on the first local computer network from the second local computer network second information submitted by a user customer remote from the first local computer network concerning a desired characteristic of the printed promotional item; and
providing onto the second local computer network from the first local computer network third information concerning a proposed design for the printed promotional item for review by the user customer.

2. The method of claim 1, further comprising:
providing onto the first local computer network fourth information concerning at least one of a plurality of possible categories of printed promotional items, a plurality of possible types of printed promotional items, and a plurality of possible formats of printed promotional items;
receiving from the second local computer network fifth information submitted by a user customer and concerning at least one of a desired category of the printed promotional item, a desired type of the printed promotional item, and a desired format of the printed promotional item.

3. The method of claim 2, wherein the categories of printed promotional items include labels, game pieces, pop materials, coupons, packaging and regional promotions and
wherein the types of printed promotional items include On-Pack promotional items, Off The Shelf promotional items, bumper stickers, cut-out coupons, and hang tags.

4. The method of claim 1, wherein the printed promotional item is an On-Pack coupon, and the plurality of characteristics include corporate sponsor, pricing point, product image, expiration date, and bar code.

5. The method of claim 1. wherein communication between the first and second local computer networks is provided by at least one of an intranet and a wireless computer network.

6. The method of claim 1, wherein the first and third information are provided as part of first and second web pages that are capable of being displayed on a user customer computer.

7. The method of claim 6, wherein the first web page includes a plurality of fields configured to receive the second information from the user customer.

8. The method of claim 6, wherein the first web page includes a list from which the desired characteristic can be selected.

9. The method of claim 6, wherein the first web page includes an image exemplifying the plurality of possible characteristics of the printed promotional item.

10. The method of claim 1, further comprising receiving from the computer network an indication that the proposed design has been approved by the user customer.

11. The method of claim 10, further comprising providing onto the computer network fourth information including an order form; and receiving from the computer network fifth information regarding an order placed by the user customer.

12. The method of claim 11, wherein the order form includes a plurality of fields for receiving order information to be entered by the user customer, and wherein the order information includes an order quantity.

13. The method of claim 1, further comprising providing over the Internet from the first local computer network fourth information concerning a user customer log in procedure; and receiving user customer identification information from the second local computer network prior to providing the first information.

14. The method of claim 1, further comprising providing over the Internet fourth information including at least one of descriptive information regarding a provider, descriptive information regarding a purpose of the printed promotional item, and an advertisement.

15. A method of designing and ordering a printed promotional item, the method comprising:
providing a first web page onto the Internet, wherein the first web page includes at least a first field within which a user customer identity can be specified;
receiving first information including an identifier indicative of a particular user customer identity;
providing a second web page onto the Internet, wherein the second web page includes a list of different printed promotional items;
receiving second information indicative of a particular printed promotional item selected from the list of different printed promotional items;
providing a third web page onto the Internet, wherein the third web page includes at least one of a second field and a list of selectable characteristics;
receiving third information indicative of a specified characteristic for the particular printed promotional item, wherein the third information is one of specified information that was entered by the user customer into the second field and selected information that was selected by the user customer from the list of selectable characteristics.

16. The method of claim 15, further comprising:
providing a fourth web page onto the Internet, wherein the fourth web page includes an image of the particular printed promotional item having the specified characteristic, and wherein the fourth web page further includes a selectable option for approving the image.

17. The method of claim 16, further comprising:
providing a fifth web page including an order form having multiple fields into which the user customer can input a plurality of data items.

18. The method of claim 15, wherein at least one of the second and third web pages is provided earlier than the providing of the first web page, and wherein the list of different printed promotional items lists printed promotional items according to at least one of different categories of printed promotional items, different types of printed promotional items, and different formats for printed promotional items.

19. The method of claim 15, wherein characteristics of the printed promotional items to be selected by the user customer are provided to the user customer based on the user customer's identity.

20. A system for designing and ordering printed promotional items:
a processing means for executing a web server application program, storing a set of web pages, and communicating with user customer computers via the Internet,
wherein the processing means is capable of sending web page information onto the Internet and is capable of receiving user customer-provided information off of the Internet, and
wherein the set of web pages includes a first web page having information concerning a plurality of possible characteristics of at least one printed promotional item, and a second web page including an order form.

21. The system of claim 20, wherein the set of web pages further includes a third web page having information concerning at least one of a plurality of different categories of printed promotional items, a plurality of different types of printed promotional items, and a plurality of different formats of printed promotional items, a fourth web page including an image of a proposed design for a printed promotional item, and a fifth web page requesting identification information from the user customer.
